(19) United States
(12) Patent Application Publication
(10) Pub. No.: US 2016/0229739 A1
(43) Pub. Date: Aug. 11, 2016

(54) TEMPERABLE ENAMELLED GLASS

(71) Applicant: SAINT-GOBAIN GLASS FRANCE, Courbevoie (FR)

(72) Inventors: Frédéric CLABAU, Paris (FR); Louis GARNIER, Paris (FR); Thomas BARRAUD, Lyon (FR); Vincent RACHET, Saint-Cyr en Val (FR)

(21) Appl. No.: 15/023,223

(22) PCT Filed: Sep. 19, 2014
(86) PCT No.: PCT/FR2014/052331

§ 371 Date: Mar. 18, 2016

(30) Foreign Application Priority Data
Sep. 20, 2013 (FR) 1359068

(51) Int. Cl. C03C 17/00; C03C 3/091; C03C 8/20

(52) U.S. Cl. CPC C03C 17/009; C03C 8/20; C03C 3/091; C03C 2204/04; C03C 2217/452

(57) ABSTRACT

A temperable glass or glass-ceramic substrate coated at least partially with a layer of enamel includes an organic resin and inorganic constituents including at least one glass frit and at least one pigment, wherein the resin includes at least one compound selected from a monomer having a functionality of between 1 and 6 and an unsaturated oligomer of acrylate type, the content of resin in the dry enamel layer being between 6% and 8.5% by weight relative to the inorganic constituents.

One subject of the present invention is a glass or glass-ceramic substrate, covered with a dry enamel layer and temperable, intended to be used in the field of internal and/or external construction, and also a process for the manufacture thereof. The substrate coated with the dry enamel layer is temperable, in the sense that it is possible to subsequently subject it to a high-temperature tempering treatment in order to obtain tempered safety glass. The enameled glass is a glass of which at least one of the faces thereof is coated with an opaque enamel layer which has been hardened or treated thermally. It is especially intended to decorate the walls of buildings or fronts of furniture. Applications of this product can be envisaged in the field of decoration and in the motor vehicle field.

The enamels used for coating glass substrates consist of a powder comprising a glass frit, inorganic pigments, optional other mineral fillers and a medium. The medium, often resin-based, ensures good slurrying of the assembly of the inorganic particles and thus the processability thereof in the liquid state. The medium is consumed during the firing of the enamel.

The main drawback of the dry enamel is that the layer deposited on the substrate has, before melting, a very low mechanical strength and hydrolytic resistance. It is not therefore possible to transport, store, cut, edge or wash a glass coated with a dry enamel while it has not been heated and while the layer deposited does not melt. This heating is often carried out at high temperature, typically above 600° C. (firing of the enamel). However, unless an additional detempering stage is carried out, it is no longer possible to customize a tempered glass. Consequently, the enamel must imperatively be deposited on panels having the final dimensions. This type of product is not very suitable for internal accommodation where the dimensions are often specific to the customer.

The solution that consists in using an organic paint makes it possible to improve the mechanical strength but does not allow high-temperature tempering. Consequently, other solutions have been envisaged. Patent application WO 2007/104752 describes a two-layer system in which a layer of resin acting as a sacrificial protective layer is deposited on a layer of enamel. This system requires numerous industrial steps since it is necessary to consolidate the first layer before being able to deposit the second. There is also a high risk of degradation of the enamel layer during the deposition of the resin layer. Above all, the amount of resin in this two-layer system is relatively high and it is difficult to remove all of the resin during the tempering, which may give rise to the appearance of black carbon-based residues that leave traces on the coated substrate. Patent application WO 2011/095471 therefore proposes a particular tempering process for this type of system. The protective overlayer of enamel envisaged does not however make it possible to improve the adhesion of the enamel layer to the glass substrate. The customization, before tempering, of this two-layer system, such as for example the steps of piercing or polishing which involve the presence of water, still remain difficult.

Another possibility envisaged for improving the mechanical strength of the enamel consists in increasing the amount of resin. Mention may be made, for example, of applications WO 2011/051459 or WO 2012/004337 which describe enamel-based coatings comprising between 11% and 40% by weight of organic materials. The main problem of these layers remains poor adhesion to the glass, mainly in the presence of water, which frequently leads to delamination of the colored layer during conventional steps of edging or piercing the coated substrate. A second potential problem, due to the high resin contents and that is troublesome from an industrial viewpoint, is the appearance of flames in the tempering furnace and of sizeable gas emissions, able to degrade the heating resistors of the furnace and to present an industrial risk. As mentioned above, a large amount of resin also leads to the appearance of black traces on the coated substrate after tempering.

It is consequently sought to develop a glass or glass-ceramic substrate coated with a layer of enamel that has the desired opacity, without requiring a high-temperature treatment of the coated substrate, while remaining transportable, storable, cuttable, edgeable, washable and temperable. It is within this context that the present invention lies.

The present invention relates to a temperable glass or glass-ceramic substrate coated at least partially with a layer of enamel comprising an organic resin and inorganic constituents including at least one glass frit and at least one pigment, wherein said resin comprises at least one compound selected from a monomer having a functionality of between 1 and 6 and an unsaturated oligomer of acrylate type, the content of resin in the layer being between 6% and 8.5% by weight relative to the inorganic constituents. This resin content is that of the dry enamel layer. Preferably, the resin content in the layer is less than or equal to 8% by weight relative to the inorganic constituents (therefore between 6% and 8% by weight relative to the inorganic constituents).

The substrate is said to be temperable since it is capable of being tempered in order to meet the safety standards.

In the remainder of the text, the “drying” of the enamel will be referred to when a liquid enamel layer is subjected to a heat treatment at a temperature below 250° C. The drying step corresponds to the crosslinking of the organic resin. After this drying step, the layer obtained is a so-called “dry” enamel layer. “Tempering” will be referred to when the heat treatment is carried out at high temperatures, conventionally at temperatures above 650° C. At the end of this high-temperature heat treatment, reference will be made to “fired” enamel.

The contents of organic resin present in the enamel layer are given after drying of the enamel, that is to say after evaporation of the solvents present, but before tempering. They therefore correspond to the contents of resin in the dry enamel layer. The percentage by weight of resin is determined relative to the total amount of inorganic materials (glass frit and mineral fillers, including the pigment) present in the enamel. The formulation of the enamel layer is prepared by mixing the various constituents, namely the glass frit, the pigment and the optional other mineral fillers and the organic compounds, so as to obtain the desired amount of organic resin. After drying, it is also possible to determine the amount of resin in the dry enamel layer by thermogravimetric analysis (TGA).

The functionality of a monomer expresses the number of reactive sites that it possesses and may be defined as being the number of covalent bonds that can be formed using this monomer under the conditions of the polymerization.

Advantageously, the organic resin may comprise a monomer of acrylate type having a functionality greater than or equal to 2. Preferably, the monomer is selected from compounds based on dimethacrylate, diacrylate, trimethacrylate, triacrylate, tetraacrylate and penta-acrylate. As examples of bifunctional monomers, mention may be made of tricyclodecane dimethanol diacrylate, tricyclodecane dimethanol dimethacrylate, 1,6-hexane-diol diacrylate, dipropylene glycol diacrylate, bisphenol A ethoxylate diacrylate, polyethylene glycol diacrylate, neopentyl glycol propoxylate diacrylate, tetraethylene glycol diacrylate, triethylene glycol diacrylate, tripropylene glycol diacrylate, 1,3-butylene glycol dimethacrylate, 1,4-butanediol dimethacrylate, 1,6-hexanediol dimethacrylate, bisphenol A ethoxylate dimethacrylate, polyethylene glycol dimethacrylate, tetraethylene glycol dimethacrylate, triethylene glycol dimethacrylate, ethylene glycol dimethacrylate and diethylene glycol dimethacrylate. As examples of trifunctional monomers, mention may be made of trimethylolpropane triacrylate, optionally trimethylolpropane ethoxylate or propoxylate triacrylate, pentaerythritol ethoxylate triacrylate, glycerol propoxylate triacrylate and trimethylolpropane trimethacrylate.

The organic resin may comprise an unsaturated oligomer which is a compound of acrylate type, preferably selected from polyether acrylates, styrene acrylates, epoxy acrylates, urethane acrylates, ammonium acrylates and polyester acrylates. Preferably, the unsaturated oligomer is a styrene acrylate or a polyurethane acrylate. These two types of acrylate advantageously make it possible to have both a good adhesion of the enamel layer to the substrate and a good scratchability.

The organic resin may also comprise a mix of monomers having a functionality between 1 and 6 and of an oligomer of acrylate type.

The use of this type of organic resin, in a lower amount than that described in the prior art, advantageously makes it possible to improve the adhesion of the dry enamel layer to the substrate, to maintain a good scratch resistance and to obtain a coated substrate which retains these mechanical properties after tempering, while limiting the presence of black carbon-based residues. The constituents of the resin make it possible in particular to provide combustibility to the resin mixture by means of a supply of oxygen within the enamel layer and enable the modification of the density of the network formed during the resin crosslinking phase. Thus, the mechanical properties of the enamel are improved. Limiting the amount of resin needed to attain the targeted level of mechanical properties favors its combustibility during tempering even more.

Advantageously, the enamel layer comprises an additive capable of releasing oxygen during drying of the layer or during tempering. This additive makes it possible to improve the combustibility while retaining good mechanical properties. It may be selected from starch, oxalates, polylactates, alkali metal nitrates, alkali metal carbonates and alkali metal sulfates. Preferably, the additive is an alkali metal nitrate, carbonate or sulfate. When it is present, this additive exists at a content between 0.01% and 5% by weight, preferably between 0.1% and 3% by weight, relative to the total weight of the constituents of the enamel layer, without taking into account the solvents.

The enamel layer has, after drying, a thickness of between 10 and 200 μm. Preferably, this thickness is between 20 and 150 μm, and, more preferably still, between 30 and 120 μm, before tempering. Reference may thus be made to a thickness of the dry enamel. This thickness must be sufficient so that the layer obtained after drying is sufficiently opaque, but must not be too large so that the resin can burn completely during the tempering. The enamel layer may cover a portion or all of at least one of the faces of the substrate.

The dry enamel layer has an adhesion to the substrate, measured in the cross-cut test according to the standard ISO 2409:2007, of less than or equal to 2, or even of less than or equal to 1.

The substrate is made of glass or of glass-ceramic. The glass may be a soda-lime-silica glass, but it may also be of any other type, for example of borosilicate or alumino-borosilicate type. It may be clear or colored.

The scratchability of the coated substrate is measured by carrying out a Clemen test, according to the standard ISO 1518-1:2011. The dry enamel layer has a scratchability of at least 2N, which is sufficient for industrial processing operations.

The coatings obtained are also characterized by measurement of the lightness component L*. The colorimetric coordinate L* is calculated by taking into account the illuminant D65 and the reference observer CIE-1931. These are colorimetric coordinates in reflection. The component L* defines the lightness, which ranges from the value 0 for black to the value 100 for white. An L* value of less than 85 for a white enamel will be characteristic of the appearance of black carbon-based residues during the tempering. The L* value measured after tempering is therefore representative of the presence of black carbon-based residues in the enamel coating layer. The desired performances are achieved if the L* value remains above after the tempering. In the examples presented below, the L* values given correspond to measurements carried out in reflection on the enamel layer side.

The substrate coated with the dry enamel layer is “temperable” and may thus meet the safety standard EN 12150-1:2000.

The present invention also relates to a process for preparing a glass or glass-ceramic substrate coated with an enamel layer, as described above. The preparation process comprises the following steps:
a) a layer of enamel comprising at least inorganic constituents, including a glass frit and a pigment, and 6% to 8.5% by weight relative to the inorganic constituents of an organic resin comprising at least one compound selected from a monomer having a functionality of between 1 and 6 and an unsaturated oligomer of acrylate type are deposited on at least one portion of one of the faces of said substrate,
b) the coated substrate is dried at a temperature below 250° C., preferably below 200° C.

The deposition of the layer carried out in step a) may be performed by any technique known to a person skilled in the art. The liquid (or pasty) layer may in particular be deposited by screen printing or according to the curtain coating technique.

Depending on the desired thickness, it can be envisaged to carry out several successive deposition steps. Preferably, each deposition step is followed by a drying step before carrying out the next deposition step.

The substrate thus obtained is temperable and may, if the user desires, be subjected to a tempering step at a temperature above 650° C.

The examples below illustrate the invention without limiting the scope thereof.

### EXAMPLE 1

An enamel composition A is prepared by mixing a glass frit, the composition of which is given below, a white inorganic pigment based on titanium dioxide sold by the company Kronos and 7% by weight with respect to the inorganic constituents of a thermosetting resin of styrene acrylate type sold by the company Cytec under the name Viacryl™ SC 6827w/46WA in water.

The glass frit has the following composition by weight:

| | |
|---|---|
| SiO₂ | 45% |
| B₂O₃ | 17% |
| Al₂O₃ | 13% |
| Na₂O | 2% |
| K₂O | 3% |
| Li₂O | 2% |
| BaO | 14% |
| MgO | 4% |

The liquid mixture is deposited by screenprinting onto a substrate made of previously cleaned extra-clear Diamant® glass, then is crosslinked at 150° C. (drying step), for a duration of 20 minutes. The thickness of the dry enamel layer, therefore after drying, is of the order of 120 μm.

An enamel composition B is prepared as described above using 7% by weight with respect to the inorganic constituents of a resin consisting of a mixture of difunctional and trifunctional acrylate monomers (25% of trimethylolpropane propoxylate triacrylate, sold by Sartomer under the reference SR492 and 25% of tricyclodecane dimethanol diacrylate, sold by Sartomer under the reference SR833S) with a polyurethane acrylate oligomer (reference CN9010EU, sold by Sartomer), the monomer/oligomer weight ratio being 50/50.

The liquid mixture is deposited on a previously cleaned glass substrate, then is crosslinked at 150° C. (drying step), for a duration of 20 minutes. The thickness of the dry enamel layer (therefore after drying) is of the order of 120 μm.

An enamel composition C is prepared in the same way as composition A, additionally adding 0.5% by weight of potassium nitrate KNO₃. The liquid mixture is deposited on a previously cleaned glass substrate, then is crosslinked at 150° C. (drying step), for a duration of 20 minutes. The thickness of the dry enamel layer (therefore after drying) is of the order of 120 μm.

The performances of the coatings before and after tempering are compared with those of the product Emalit®, which is an enamel comprising 3% by weight of cellulose resin, and with those of a conventional automotive enamel comprising 15% by weight of acrylate resin and in which the black pigment customarily used in the automotive field has been replaced by a white pigment.

The results obtained are given in the following table.

| | | | L* after |
|---|---|---|---|
| | Scratchability | Adhesion | tempering at |
| | before | before | 700° C. for |
| | tempering (N) | tempering | 10 minutes |
| | (dry enamel) | (dry enamel) | (fired enamel) |
| Enamel A | 2 | 1 | 88 |
| according to | | | |
| the invention | | | |
| Enamel B | 2 | 2 | 89.7 |
| according to | | | |
| the invention | | | |
| Enamel C | 2 | 2 | 91.8 |
| according to | | | |
| the invention | | | |
| Emalit ® | 2 | 5 | 91.3 |
| (comparative) | | | |
| Automotive | 5 | 1 | 60 |
| enamel | | | |
| (comparative) | | | |

If the mechanical properties obtained for Emalit® and the automotive enamel are compared, it is observed that the scratchability and the adhesion are greatly improved with the use of a larger amount of resin (the adhesion rating is even lower since the layer adheres to the substrate). However, this improvement is made to the detriment of the quality of the coated substrate after tempering, since the low value of L* after tempering indicates the presence of a large amount of black carbon-based residues in the case of the automotive enamel.

The enamel compositions A, B and C according to the present invention make it possible to provide both a good mechanical strength and a good combustibility. The products thus obtained meet the specifications of the desired application.

### EXAMPLE 2

Three enamel compositions were prepared in the same way as composition A from example 1, by varying the amount of Viacryl™ SC 6827w/46WA resin. The resin contents in the enamel layer after drying are respectively 2.5%, 4%, 6% and 16% by weight. The application of the 80 μm enamel layer was carried out using a film coater on a Diamant® extra-clear glass.

The mechanical characteristics obtained on these samples are summarized in the following table:

| | | | L* after |
|---|---|---|---|
| | Scratchability | Adhesion | tempering at |
| | before tempering | before | 700° C. for |
| Resin content | (in N) | tempering | 10 minutes |
| (% by weight) | (dry enamel) | (dry enamel) | (fired enamel) |
| 2.5% | Less than 1 | 3 | 90 |
| 4% | 1 | 3 | 88 |
| 6% | 2 | 2 | 87 |
| 8% | 2 | 2 | 86 |
| 16% | 3 | 0 | 84 |

1. A temperable glass or glass-ceramic substrate coated at least partially with a layer of enamel comprising an organic resin and inorganic constituents including at least one glass frit and at least one pigment, wherein said organic resin comprises at least one compound selected from a monomer having a functionality of between 1 and 6 and an unsaturated oligomer of acrylate type, the content of the organic resin in the layer being between 6% and 8.5% by weight relative to the inorganic constituents.

2. The substrate as claimed in claim 1, wherein the organic resin content is less than or equal to 8% by weight relative to the inorganic constituents.

3. The substrate as claimed in either of claim 1, wherein the organic resin comprises a monomer of acrylate type having a functionality of greater than or equal to 2.

4. The substrate as claimed in claim 1, wherein the organic resin comprises an unsaturated oligomer selected from polyether acrylates, styrene acrylates, epoxy acrylates, urethane acrylates, ammonium acrylates and polyester acrylates.

5. The substrate as claimed in claim 4, wherein the unsaturated oligomer is a styrene acrylate or a polyurethane acrylate.

6. The substrate as claimed in claim 1, wherein the enamel layer additionally comprises at least one additive selected from starch, oxalates, polylactates, alkali metal nitrates, alkali metal carbonates and alkali metal sulfates.

7. The substrate as claimed in claim 6, wherein the additive content is between 0.01% and 5% by weight relative to the total weight of the constituents of the enamel layer.

8. The substrate as claimed in claim 1, wherein the enamel layer, after drying at a temperature below 250° C., has a thickness of between 10 and 200 μm.

9. A process for preparing a glass or glass-ceramic substrate coated with an enamel layer as claimed in claim 1, the process comprising:
(a) depositing a layer of enamel comprising inorganic constituents, including at least one glass frit and at least one pigment, and 6% to 8.5% by weight relative to the inorganic constituents of an organic resin comprising at least one compound selected from a monomer having a functionality of between 1 and 6 and an unsaturated oligomer of acrylate type on at least one portion of one of the faces of said substrate,
(b) drying the coated substrate at a temperature below 250° C.

10. The substrate as claimed in claim 3, wherein the monomer is selected from compounds based on dimethacrylate, diacrylate, trimethacrylate, triacrylate, tetraacrylate and pentaacrylate.

11. The substrate as claimed in claim 7, wherein the additive content is between 0.1% and 3% by weight relative to the total weight of the constituents of the enamel layer.

12. The substrate as claimed in claim 8, wherein the enamel layer, after drying at a temperature below 250° C., has a thickness of between 20 and 150 μm.

13. The substrate as claimed in claim 12, wherein the enamel layer, after drying at a temperature below 250° C., has a thickness of between 30 and 120 μm.

14. The process as claimed in claim 9, wherein the coated substrate is dried at a temperature below 200° C.
